(19) United States
(12) Patent Application Publication
(10) Pub. No.: US 2004/0215682 A1
(43) Pub. Date: Oct. 28, 2004

(54) Apparatus for removing aliasing of inverse mapping algorithm

(76) Inventor: Sang Yeon Kim, Gunpo (KR)

Correspondence Address: BIRCH STEWART KOLASCH & BIRCH, PO BOX 747, FALLS CHURCH, VA, 22040-0747, US

(21) Appl. No.: 10/828,200

(22) Filed: Apr. 21, 2004

(30) Foreign Application Priority Data
Apr. 22, 2003 (KR) 25376/2003

(51) Int. Cl. G06F 17/10

(52) U.S. Cl. 708/300

(57) ABSTRACT

An apparatus for removing aliasing of an inverse mapping algorithm includes a tap delay unit for sequentially delaying input data; a coefficient updating unit for multiplying a selected filter coefficient to preceding data inputted to the tap delay unit and subsequent data outputted through the tap delay unit according to a range of a re-sampling interval and outputting them; an adding unit for adding output values of the coefficient updating unit and outputting them; and an interpolating unit for interpolating data outputted from the adding unit and outputting re-sampled data. Aliasing that may be generated when a warping is performed to correct optical distortion can be removed to enhance a picture quality.

### BACKGROUND OF THE INVENTION

1. Field of the Invention

The present invention relates to an inverse mapping algorithm and, more particularly, to an apparatus for removing aliasing of an inverse mapping algorithm without blurring distortion.

2. Description of the Background Art

In general, an image warping is used to correct geometrical distortion such as a pin cushion, a barrel, a keystone, a skew or a tilt which frequently appears in a display unit such as a projection TV, a projector or a monitor.

The image warping is an algorithm for creating a deformed image by performing a coordinate conversion for an image, thereby obtaining a distortion-corrected image. The spatial coordination conversion is expressed as a polynomial function, and the above-mentioned distortion can be expressed as a third polynomial function by equation (1) shown below:

u=a₀₀+a₀₁y+a₀₂y²+a₀₃y³+a₁₀x+a₁₁xy+a₁₂xy²+a₂₀x²+a₂₁x²y+a₃₀x³

v=b₀₀+b₀₁y+b₀₂y²+b₀₃y³+b₁₀x+b₁₁xy+b₁₂xy²+b₂₀x²+b₂₁x²y+b₃₀x³ (1)

wherein (u,v) is a coordinate of a source image, and (x,y) is a coordinate of a target image.

Equation (1) is called an inverse mapping function because a coordinate of a source image is calculated by taking a coordinate of a target image as an independent variable. A forward mapping function can be easily obtained by changing the coordinate of the source image and that of the target image in equation (1). However, in the forward mapping, an overlap phenomenon occurs that a non-mapped pixel (hole) is generated or several input pixels are mapped to one pixel. Thus, the inverse mapping is commonly used.

FIG. 1 is an exemplary view showing a coordinate of the source image and that of the target image when a general inverse mapping is applied, and FIG. 2 is an exemplary view showing a general pincushion deformation.

As shown in FIG. 1, in general, a coordinate of the source image calculated through the inverse mapping related equation upon receiving a coordinate of the target image does not only correspond to a pixel position of the source image but also a sampling interval differs, so re-sampling is requested. Herein, the interval of the re-sampling is not uniform but varied depending on the type of coordinate conversion and a position of a spatial coordinate. For example, in FIG. 2, when the pincushion is applied, the sampling interval at the edge portion of an image is larger than that of the middle portion. Thus, aliasing is severe at the edge portion. If a filter of a fixed coefficient is used in order to remove such phenomenon, an unnecessary blurring is generated at the edge portion of the image, and in order to design the filter on the basis of the edge portion, aliaing at the middle portion is not sufficiently removed.

### SUMMARY OF THE INVENTION

Therefore, an object of the present invention is to provide an apparatus for removing aliasing of an inverse mapping algorithm capable of removing aliasing without a blurring artifact by varying a filter coefficient through a filter coefficient through a filter coefficient set formed according to a re-sampling interval in applying an inverse mapping algorithm.

To achieve these and other advantages and in accordance with the purpose of the present invention, as embodied and broadly described herein, there is provided an apparatus for removing aliasing of an inverse mapping algorithm, including: a tap delay unit for sequentially delaying input data; a coefficient updating unit for multiplying a selected filter coefficient to preceding data inputted to the tap delay unit and subsequent data outputted through the tap delay unit according to a range of a re-sampling interval and outputting them; an adding unit for adding output values of the coefficient updating unit and outputting them; and an interpolating unit for interpolating data outputted from the adding unit and outputting re-sampled data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view showing a source image coordinate and a target image coordinate when a general inverse mapping is applied;

FIG. 2 is an exemplary view showing a general pincushion deformation;

FIG. 3 is an exemplary view showing a coordinate conversion performing process in accordance with the present invention;

FIG. 4 is an exemplary view showing a method for performing a filtering in accordance with the present invention; and

FIG. 5 is an exemplary view showing the construction of an anti-aliasing filter and an interpolator in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

An apparatus for removing aliasing of an interval mapping algorithm, which is capable of removing aliasing without a blurring artifact by varying a filter coefficient through a filter coefficient set formed according to a re-sampling interval in applying an inverse mapping algorithm, in accordance with a preferred embodiment of the present invention will now be described with reference to the accompanying drawings.

In general, an image warping algorithm is expressed as a two-dimensional function for a spatial coordinate conversion, so it is not a horizontally and vertically separable algorithm in terms of a general concept.

However, the image warping algorithm can be applied as a horizontally and vertically separated scan line algorithm if a constraint is allowed for the function for a geometrical processing. In this case, a horizontal coordinate conversion and vertical coordinate conversion are independently performed in turn, and two-dimensional re-sampling is simplified to one-dimensional re-sampling matter.

The above-described content can be expressed by equation (2) shown below:

U=f(x), v=G(y) (2)

wherein ‘u’ and ‘v’ are horizontal and vertical source image coordinates, respectively, ‘x’ and ‘y’ are horizontal and vertical target image coordinates, respectively, and ‘F’ and ‘G’ are horizontal and vertical coordinate conversion functions, respectively.

FIG. 3 is an exemplary view showing a coordinate conversion performing process in accordance with the present invention.

As shown in FIG. 3, it is noted that the sampling position according to performing of the coordinate conversion in the horizontal direction through the scan line algorithm does not correspond to the pixel position of the source image and the sampling rate is varied according to the position. In this case, if the sampling rate is smaller than the sampling rate of the source image, aliasing occurs. Thus, an anti-aliasing filtering is performed according to the sampling rate and an interpolation is to be performed to obtain a sample among pixels. Also, the interpolation uses an interpolation coefficient, namely, a distance value between a pixel of a target image positioned between two neighboring pixels of the source image and a pixel of the source image when a distance between two neighboring pixels of the source image is normalized as 1.

A re-sampling rate at a coordinate ‘x’ of the current target image can be calculated by equation (3) shown below:

$$\begin{matrix}Δ = \frac{{u}^{+} - {u}^{-}}{2} , & {f}_{RS} = \frac{1}{Δ}\end{matrix} \qquad ( 3 )$$

wherein Δ indicates a re-sampling interval and f_{RS} indicates a re-sampling rate.

If u-F(x) is a current calculated ‘u’ coordinate of a source image, u⁺ is a ‘u’ coordinate of the source image which has been calculated before the current coordinate (u) and u⁻ is a ‘u’ coordinate of the source image which has been calculated after the current coordinate (u).

In this case, if Δ≦1, it means that the re-sampling rate is greater than or the same as the sample rate of the source image, so that an anti-aliasing filtering is not required. If, however, Δ>1, it means that the re-sampling rate is smaller than the sample rate of the source image, so aliasing occurs. Then, filtering should be performed by using a cutoff frequency.

$${f}_{Cutoff} = \frac{{F}_{RS}}{2} .$$

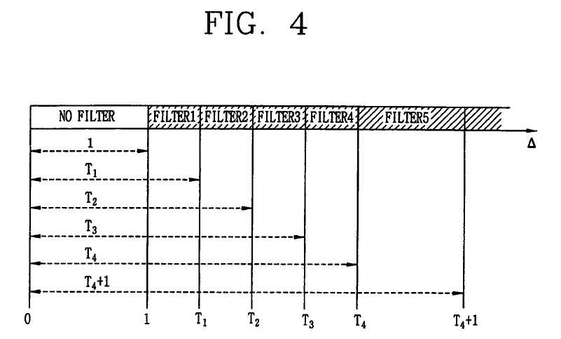

FIG. 4 is an exemplary view showing a method for performing a filtering in accordance with the present invention.

As shown in FIG. 4, in the present invention, the re-sampling interval (Δ value) is divided into certain several regions and a filtering is performed by using a filter coefficient suitable for each region.

For instance, if the re-sampling interval is divided into six regions as shown in FIG. 4, an anti-aliasing filtering can be performed by five filter sets. In this case, cutoff frequencies for each filter can be expressed by equation (4) shown below:

$$\begin{matrix}{f}_{cutoff}^{1} = \frac{1}{1 + {T}_{1}} \\ {f}_{cutoff}^{5} = \frac{1}{2 {T}_{4} + 1} \\ {f}_{cutoff}^{1} = \frac{1}{{T}_{i - 1} + {T}_{i}} , i = 2 , 3 , 4\end{matrix} \qquad ( 4 )$$

wherein f_{cutoff}¹ indicates a cutoff frequency of filters in each region.

The apparatus for removing aliasing of an inverse mapping algorithm of the present invention employs widely known bilinear interpolation that searches a value at an arbitrary position interposed between two data, together with the above-described principle.

For instance, the anti-aliasing filter uses 5-tap FIR (Finite Impulse Response) filter of five sets, and has a structure for simultaneously outputting two adjacent filtering results. A bilinearly interpolated result obtained from the two filtering result values is outputted as a re-sampling value.

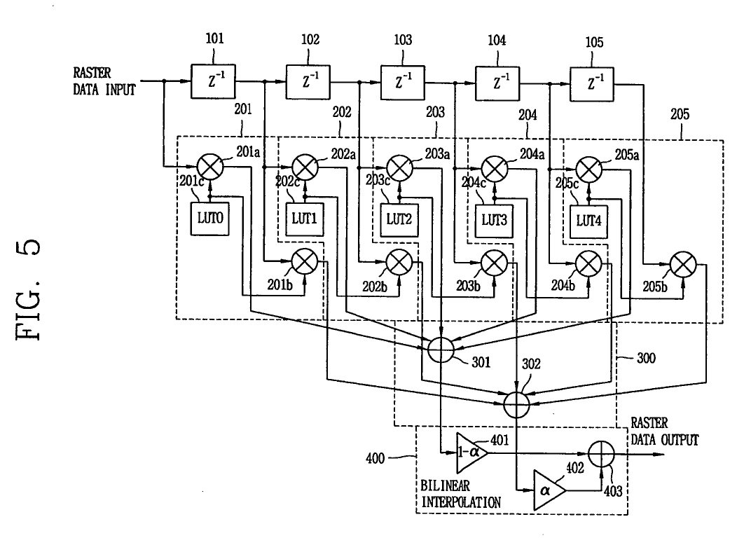

FIG. 5 is an exemplary view showing the construction of an anti-aliasing filter and an interpolator in accordance with the present invention.

As shown in FIG. 5, the anti-aliasing filter includes: a plurality of tap delay units 101˜105 connected in series to each other and sequentially delaying input data (namely, raster data); a plurality of coefficient updating units 201˜205 including first to fifth look-up tables (LUT) 201c˜205c having a plurality of filter coefficient according to a range of a re-sampling interval (Δ value), first multipliers 201a˜205a for multiplying preceding data inputted to the plurality of tap delay units 101˜105 and a filter coefficient selected in the plurality of look-up tables 201c˜205c, and second multipliers 201b˜205b for multiplying subsequent data inputted to the plurality of tap delay units 101˜105 and a filter coefficient selected in the plurality of look-up tables 201c˜205c; an adding unit 300 having a first adder for adding outputs of the first multipliers of the coefficient updating units 201˜205 and a second adder 302 for adding outputs of the second multipliers of the coefficient updating units 201˜205; and an interpolator 400 having a third multiplier 401 for multiplying 1−α to the output of the first adder 301 of the adding unit 300, a fourth multiplier 402 for multiplying a to the output of the second adder 302 of the adding unit 300, and an adder 403 for adding outputs of the third multiplier 401 and the fourth multiplier 402 and outputting re-sampled data.

The coefficient updating units are provided as many as the filter taps. Thus, the first coefficient updating unit 201 includes a first look-up table 201c for selectively outputting one of a plurality of previously stored filter coefficients according to a range of the re-sampling interval (Δ value), a first multiplier 201a for multiplying a filter coefficient outputted from the look-up table 201c to the input data, and a second multiplier 201b for multiplying the filter coefficient to output data of the first tap delay unit 101.

The second coefficient updating unit 202 includes a second look-up table 202c for selectively outputting one of a plurality of previously stored filter coefficients according to a re-sampling interval (Δ value), a first multiplier 202a for multiplying a filter coefficient outputted from the look-up table 202c to output data of the first tap delay unit 101, and a second multiplier 202b for multiplying the filter coefficient to output data of the second tap delay unit 102. The third to fifth coefficient updating units 203˜205 also have the same construction.

The first to fifth look-up tables 201c˜205c selectively output one of five sets of filter coefficients according to the range of the re-sampling interval (Δ value) in Table 1 as shown below. Besides the filter coefficients of each filter set, threshold values (T1˜T4) determining the filter set can be also varied.

TABLE 1

| Range of | LUTO | LUTO | | LUTO | LUTO |
|---|---|---|---|---|---|
| Δ value | output | output | LUTO output | output | output |
| 0≦ Δ ≦ 1 | 1 | 0 | 0 | 0 | 0 |
| 1<Δ ≦ T₁ | Filt1_Coef0 | Filt1_Coef1 | Filt1_Coef2 | Filt1_Coef3 | Filt1_Coef4 |
| T₁<Δ ≦ T₂ | Filt2_Coef0 | Filt2_Coef1 | Filt2_Coef2 | Filt2_Coef3 | Filt2_Coef4 |
| T₂<Δ ≦ T₃ | Filt3_Coef0 | Filt3_Coef1 | Filt3_Coef2 | Filt3_Coef3 | Filt3_Coef4 |
| T₃<Δ ≦ T₄ | Filt4_Coef0 | Filt4_Coef1 | Filt4_Coef2 | Filt4_Coef3 | Filt4_Coef4 |
| T_{4<Δ} | Filt5_Coef0 | Filt5_Coef1 | Filt5_Coef2 | Filt5_Coef3 | Filt5_Coef4 |

The apparatus for removing aliasing of an inverse mapping algorithm constructed as described above operates as follows.

First, Raster-scanned input data is sequentially delayed in the first to fifth tap delay units 101˜105 and outputted to the first to fifth coefficient updating units 201˜205, respectively.

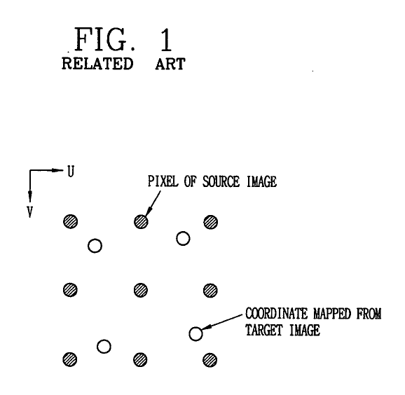

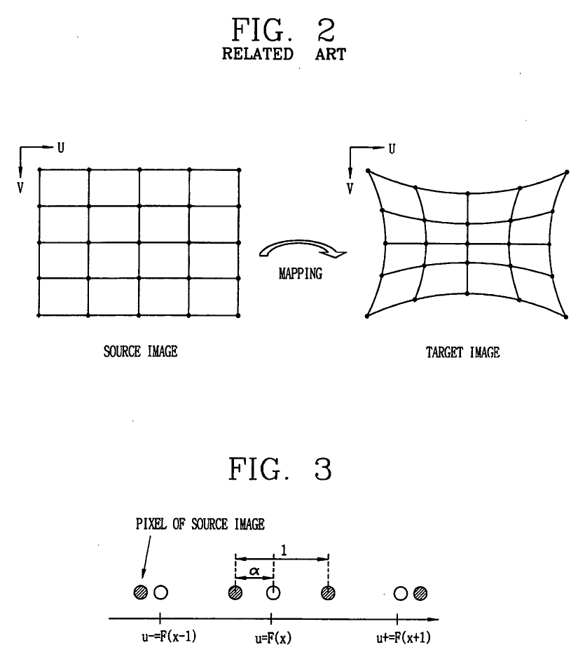

The look-up tables 201c of the first to fifth coefficient updating unit 201 selectively outputs one of the plurality of filter coefficients which has been previously stored as shown in FIG. 1 according to the range of the Δ value to the first and the second multipliers 201a and 201b. The first multiplier 201a multiplies the filter coefficient outputted from the look-up table 201c and input data and outputs it to the first adder 301 of the adding unit, and the second multiplier 201b multiplies a filter coefficient outputted from the look-up table 201c to output data of the first tap delay unit 101 and outputs it to the second adder 302 of the adding unit 300.

For instance, if the re-sampling interval (Δ) is 0≦Δ≦1, it means a case that the re-sampling rate is greater than or the same as a sample rate of a source image, so an anti-aliasing filtering is not necessary. Thus, the look-up table 201c outputs 1 and the look-up table 202c˜205c of the second to fifth coefficient updating units output 0. However, if the re-sampling interval (Δ) is 1<Δ≦T₁, because the re-sampling interval (Δ) is larger than 1, the re-sampling rate is smaller than the sample rate of the source image, generating aliasing, for which, thus, anti-aliasing needs to be performed. In the case of 1<Δ≦T₁, the look-up table 201c outputs Filt_Coef0, as a filter coefficient, to the first and second multipliers 201a and 201b.

The second to fifth coefficient updating units 202˜205 update filter coefficients through the same process as in the first coefficient updating unit 201.

In the adding unit, the first adder 301 adds outputs of the first multipliers 201a˜205a of the first to fifth coefficient updating units 201˜205 and outputs it to the third multiplier 401 of the interpolator 400, and the second adder 302 adds outputs of the second multipliers 201b˜205b of the first to fifth coefficient updating units 201˜205 and outputs it to the fourth multiplier 402 of the interpolator 400.

Thereafter, in the interpolator 401, the first multiplier 401 multiplies 1−α to the output of the first adder 301 of the adding unit 300 and outputs it to the adder 403, and the fourth multiplier 402 multiplies a to the output of the second adder 302 of the adding unit 300 and outputs it to the adder 403. Then, the adder 403 adds the outputs of the third multiplier 401 and the fourth multiplier 402 and outputs re-sampled data.

As so far described, the apparatus for removing aliasing of an inverse mapping algorithm has the following advantages.

That is, for example, a filter coefficient is varied according to a re-sampling interval with five filter coefficient sets, so that aliasing that may be generated in performing a warping to correct optical distortion can be removed without blurring distortion. Namely, a picture quality of an image warped when geometrical distortion generated due to mechanical or optical deformation is corrected by applying an inverse mapping algorithm is enhanced, so an improved picture quality can be provided to heighten a value of the product.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for removing aliasing of an inverse mapping algorithm, comprising:
a tap delay unit for sequentially delaying input data;
a coefficient updating unit for multiplying a selected filter coefficient to preceding data inputted to the tap delay unit and subsequent data outputted through the tap delay unit according to a range of a re-sampling interval and outputting them;
an adding unit for adding output values of the coefficient updating unit and outputting them; and
an interpolating unit for interpolating data outputted from the adding unit and outputting re-sampled data.

2. The apparatus of claim 1, wherein the coefficient updating units are provided as many as the filter taps.

3. The apparatus of claim 1, wherein the re-sampling interval is a value obtained by dividing the sum of a coordinate of a source image calculated before a current coordinate and a coordinate of the source image calculated after the current coordinate by 2.

4. The apparatus of claim 1, wherein the coefficient updating unit comprises:
a look-up table having the filter coefficient;
a first multiplier for multiplying the preceding data and the filter coefficient; and
a second multiplier for multiplying the subsequent data and the filter coefficient.

5. The apparatus of claim 4, wherein the look-up table includes a plurality of filter coefficient values according to a range of the re-sampling interval.

6. The apparatus of claim 5, wherein if the re-sampling interval is smaller than or the same as 1 (Δ≦1), an anti-aliasing filtering is not performed.

7. The apparatus of claim 6, wherein there are a plurality of look-up takes, of which a first look-up table outputs 1 and the other look-up tables output 0, thereby performing an anti-aliasing filtering.

8. The apparatus of claim 5, wherein if the re-sampling interval is greater than 1, the look-up table selectively outputs one of filter coefficients discriminated by a threshold value.

9. The apparatus of claim 8, wherein the filter coefficient and the threshold value are varied.

10. The apparatus of claim 4, wherein the adding unit comprises:
a first adder for adding all the outputs of the first multiplier; and
a second adder for adding all the outputs of the second multiplier.

11. The apparatus of claim 1, wherein interpolation of the interpolator uses an interpolation coefficient, namely, a distance value between a pixel of a target image positioned between two neighboring pixels of the source image and a pixel of the source image when a distance between two neighboring pixels of the source image is normalized as 1.

12. The apparatus of claim 1, wherein the interpolator comprises:
a third multiplier for multiplying 1−α to an output of the first adder of the adding unit;
a fourth multiplier for multiplying α to an output of the second adder of the adding unit; and
an adder for adding outputs of the third and fourth multipliers and outputting re-sampled data.

13. The apparatus of claim 1, wherein the filter including the tap delay unit, the coefficient updating unit and the adder is a 5-tap FIR (Finite Impulse Response) filter.

14. The apparatus of claim 1, wherein the plurality of tap delay units are connected in series to each other.

15. The apparatus of claim 1, wherein the input data is raster data.

16. An apparatus for removing aliasing of an inverse mapping algorithm, comprising:
a plurality of tap delay units for sequentially delaying input data;
a plurality of coefficient updating units including first to fifth look-up tables (LUTs) having a plurality of filter coefficient according to a range of a re-sampling interval, first multipliers for multiplying preceding data inputted to the plurality of tap delay units and a filter coefficient selected in the plurality of look-up tables, and second multipliers for multiplying subsequent data inputted to the plurality of tap delay units and a filter coefficient selected in the plurality of look-up tables;
an adding unit having a first adder for adding outputs of the first multipliers of the coefficient updating units and a second adder for adding outputs of the second multipliers of the coefficient updating units; and
an interpolator for interpolating data outputted from the adding unit by using an interpolation coefficient and outputting re-sampled data.

17. The apparatus of claim 16, wherein the re-sampling interval is a value obtained by dividing the sum of a coordinate of a source image calculated before a current coordinate and a coordinate of the source image calculated after the current coordinate by 2.

18. The apparatus of claim 17, wherein if the re-sampling interval is larger than 1, the look-up table selectively outputs one of filter coefficients discriminated by a threshold value, and if the re-sampling interval is smaller than or the same as 1, an anti-aliasing filtering is not performed.

19. The apparatus of claim 16, wherein when a distance between two neighboring pixels of the source image is normalized as 1, an interpolation coefficient of the interpolator is a distance value between a pixel of a target image positioned between two neighboring pixels of the source image and a pixel of the source image.
